(19) United States
(12) Patent Application Publication
(10) Pub. No.: US 2011/0011133 A1
(43) Pub. Date: Jan. 20, 2011

(54) LIGHTING DEVICE WITH LENS, AND MANUFACTURING PROCESS FOR MAKING THE SAME

(76) Inventors: Doris MOSELER, Budenheim (DE); Polina Ebeling, Heidesheim (DE); Steffen Koerner, Delligsen (DE); Ralf Bonitz, Stadecken-Elsheim (DE); Frank Peters, Delligsen (DE); Helmut Larm, Alfeld (DE)

Correspondence Address: HARNESS, DICKEY & PIERCE, P.L.C., P.O. BOX 828, BLOOMFIELD HILLS, MI, 48303, US

(21) Appl. No.: 12/888,706

(22) Filed: Sep. 23, 2010

Related U.S. Application Data
(63) Continuation of application No. 11/099,973, filed on Apr. 6, 2005.

(30) Foreign Application Priority Data
Apr. 8, 2004 (DE) 10 2004 018 424.0

(51) Int. Cl. C03B 11/00; G02B 3/00

(52) U.S. Cl. 65/61; 65/90; 65/85

(57) ABSTRACT

A lens is disclosed for lighting purposes suited in particular as a lens for a poly-ellipsoid reflector headlamp for imaging the light emitted by a light source and reflected by a poly-ellipsoid reflector for the purpose of producing a predetermined lighting pattern. At least one of the two lens surfaces comprises areas having different optical scattering effects which areas are configured as zones that are transferred from a mold to the surface by a hot-pressing process.

### CROSS-REFERENCE TO RELATED APPLICATIONS

The present application is a continuation of U.S. application Ser. No. 11/099,973, filed Apr. 6, 2005, now abandoned, which claims priority to German Application No. 10 2004 018 424.0, filed Apr. 8, 2004. The entire contents of these priority applications are incorporated herein by reference.

### BACKGROUND OF THE INVENTION

The present invention relates to a lens for lighting purposes, in particular to a lens for a headlamp, serving to image the light emitted by a light source and reflected by a reflector for the purpose of producing a predetermined lighting pattern, the lens having two surfaces arranged one opposite the other.

The invention further relates to a method for producing such a lens and a lighting device, in particular a headlamp for motor vehicle applications, which comprises such a lens.

Since the middle of the eighties vendors have offered, for upper-class and the upper middle-class automobiles, a so-called “poly-ellipsoid headlamp” (PES) in which a plano-aspheric surface, tuned to a triplex ellipsoid reflector or, most recently, to free-form surface reflectors, is used as lens, instead of the diffuser.

Such an ellipsoid headlamp (hereinafter generally referred to as “PES headlamp”) is described, for example, in DE 198 44 235 A1. The PES headlamp described by this publication comprises a reflector which consists of a segment of an ellipse and which comprises a single light source arranged in the area of the first focal point of the reflector. Provided in this headlamp, at a distance from the reflector, is a plano-convex lens which has its focal point located in an area of the second focal point of the reflector. The rays emitted by the light source in the direction of the reflector are reflected, and the reflected rays, which converge in the zone of the second focal point of the reflector, pass the lens and leave the headlamp along a line which extends approximately parallel to the axis of the plano-convex lens. A mask inserted between the reflector and the plano-convex lens is located in an area of the second focal point of the reflector. The mask has a correspondingly adapted shape to ensure that the light beam issuing from the headlamp complies with the prescribed low-beam cut-off (HDG).

PES headlamps are subject to strict legal specifications in order to prevent dazzling of the oncoming traffic. There exist diverse prescribed illuminance values for the emitted light beam that must be met in specified directions and distances. In addition, it is a requirement that color dispersion, which naturally occurs, should be limited to a given level. Further, precise adjustability of the low-beam cut-off of the headlamp is required, which must be well-defined and must not be impaired by relative color maxima.

Relevant national test standards include provisions, which for example divide the light distribution of a headlamp into different zones on a measuring screen located at a distance of 25 meters and define a plurality of test points. One important parameter in this connection is the illuminance value at a point known as HV point, which is located 25 cm above the low-beam cut-off, at the center of the light beam. The illuminance value must not exceed a defined value at this point. The HV point is located in the dark zone of the light distribution pattern. If imaging is too unsharp, the low-beam cut-off gets wider, and the illuminance value at the HV point may exceed the admissible limit value.

On the other hand, it is a requirement for certain PES headlamps that the transition at the low-beam cut-off (HDG) from the light to the dark area be relatively smooth, a condition which is expressed by the so-called HDG-value which should lie within a certain tolerance band.

Given the fact that the different individual components, in particular the reflector and the lens, must be optimally tuned one to the other in the headlamp system as a whole, some of the manufacturers of headlamps prescribe even stricter specifications for the lens than the relevant test standards. As regards the HV value, for example, the legal specification prescribes that HV<1 lux, while some manufacturers of headlamps prescribe even lower values.

If at the same time a smooth transition at the low-beam cut-off is required, this has an influence also on the HV value. A sharp low-beam cut-off may have the result that under certain circumstances the requirement of a smooth HDG transition can no longer be met if the other headlamp specifications are complied with.

According to DE 198 44 235 A1 mentioned at the outset, an additional mirror is provided, which is located between the bezel and the lens and is exposed in such a way that direct light rays emitted by the light source are reflected onto the front surface of the bezel, from which they are scattered toward the lens. This leads to a softer low-beam cut-off of the headlamp. On the other hand, this of course also leads to an increased illuminance value in the dark field so that the HV value will probably no longer be met by such a design.

DE 198 14 480 A1 describes another PES headlamp wherein an additional light source, intended to provide a position light, is arranged on a marginal area of the reflector. There is further provided an at least partially light-transmitting element, which surrounds the lens over at least part of its periphery, and which is passed by light emitted by the light source that cannot be captured by the reflector, and by light emitted by the additional light source. That element is provided, on its side facing the light source, with annular optical profiles intended to form a Fresnel lens. It is the intention of that arrangement to achieve effective illumination by the use of both light emitted by the light source and light emitted by the additional light source.

Such a structure of a headlamp is relatively complex and expensive. Also, it is not guaranteed that the headlamp specifications will be met with respect to the HV value and the HDG value.

The use of different diffractive optical elements (DOE) for the purpose of meeting the headlamp specifications (cf. WO 99/00623), in combination with the convex lens, is also expensive and requires precise tuning if the requirements regarding the intensity distribution of the light beam and regarding the color distribution and the adjustability of the headlamp are to be met.

One approach toward meeting the specifications regarding the HV value and the HDG value by giving the lens a specific design is to first produce the lenses by hot-pressing, for example according to DE 100 43 065 A1, to then surface-grind one side and polish the other side of the lenses, and to finally roughen the full surface on the convex side, for example by an abrasive blasting process. If the process is suitably conducted, the before-mentioned requirements regarding the HV value and the HDG value can then be met with the aid of lenses produced in this way.

On the other hand, the production process for such lenses is relatively complex and expensive due to the polishing treatment and abrasive blasting process required.

### SUMMARY OF THE INVENTION

It is a first object of the present invention to provide an improved lens for lighting purposes allowing a simple and cost-effective manufacture.

It is a second object of the invention to provide a lens suitable for use in a headlamp to generate a light pattern meeting different governmental or corporate standards.

It is a third object of the invention to provide a headlamp suitable for automobile applications having a simple and cost-effective design.

It is a forth object of the invention to provide a manufacturing process for the production of such a lens, by which simple and low-cost production of the lenses is rendered possible and, at the same time, the predetermined specifications for use of such lenses in a PES headlamp are complied with.

It is still another object of the invention to provide a lighting device, in particular a PES headlamp suited for motor vehicle applications, that comprises a lens of that kind.

In addition, the invention is intended to provide a suitable way of manufacturing such a lens by hot-pressing.

These and other objects of the invention are achieved by a lens for lighting purposes, in particular a lens for a headlamp, serving to image the light emitted by a light source and reflected by a reflector for the purpose of producing a predetermined lighting pattern, wherein the lens comprises two surfaces arranged one opposite the other and wherein areas having different optical scattering effects are provided on at least a first surface.

The object of the invention is perfectly achieved in this way.

It has been found that improved scattering properties of the lens can be achieved solely by the fact that rather than giving the entire surface of the lens a uniform optical scattering effect, certain specific surface areas of the lens are made to have a higher optical scattering effect than other areas. With the aid of the invention it is possible to comply with the lower HV value and simultaneously to provide a smooth transition at the low-beam cut-off. These properties of the lens, or of the lighting device in which the lens is fitted, can be achieved according to the invention without any after-treatment of the lens being required.

This is so because according to an advantageous further development of the invention the areas having different optical scattering effects or surface roughness values are configured as areas that are transferred from a mold to the first surface by hot-pressing.

This provides an in particular simple and low-cost manufacturing process with high reproducibility. And a cost-intensive after-treatment of the lens after the pressing process is no longer necessary.

According to a further preferred embodiment of the invention, the first surface comprises a marginal area having a first surface roughness and another area, following the first area in the direction of the center, which exhibits a surface roughness higher than the first surface roughness.

It has been detected by the invention that in particular advantageous properties regarding the scattering behavior and/or the color behavior can be achieved when the lens is plain (i.e. optically bright) in its marginal area, and is provided with increased surface roughness in an area adjacent that marginal area.

According to an advantageous further development of that configuration, the marginal area has a diameter d which extends over an area equal to D≦d≦0.65 D, preferably over an area equal to D≦d≦0.75 D, most preferably over an area equal to approximately D≦d≦0.8 D, where D is the optically effective outer diameter of the lens.

It has been found that in particular favorable properties of the lens can be achieved when the marginal area, which has a lower optical scattering effect and which, preferably, is optically bright, extends over such an area.

According to another embodiment of the invention, the optical scattering effect decreases in a direction from the edge toward the center, at least in a partial area of the first surface.

This also permits an in particular favorable scattering effect of the lens to be achieved.

According to another embodiment of the invention, the first surface comprises a central area that has a lower optical scattering effect than an area adjacent that central area.

This embodiment makes use of the discovery that the central area is anyway of practically no importance for the behavior in the dark zone and for the behavior at the low-beam cut-off in headlamps of the kind in which the lens is preferably employed.

According to another advantageous embodiment of the invention, the areas having a higher optical scattering effect have a mean peak-to-valley height rₘ of maximally 10 micrometers, mostly in the range of approximately 3 to 5 micrometers. In contrast, the areas having a lower optical scattering effect have a mean peak-to-valley height of maximally 1 micrometer. As far as plain or optically bright surfaces are concerned, the mean peak-to-valley height is even clearly lower, approximately in the order of 400 nm.

According to a preferred further development of the invention, the first surface of the lens has a convex, the second surface of the lens has a planar shape.

Such a design is in particular well suited for use in a PES headlamp. The areas having different optical scattering effects are preferably provided in this case on the first surface of the lens, i.e. on its convex surface.

Although it is not generally excluded to provide the areas having different optical scattering effects additionally or alternatively on the planar surface of the lens, the light-scattering effect of the lens tends to increase the scattering angle in this case, which means that it may become more difficult to comply with an HV value with strict tolerances.

The lens according to the invention may have a rotationally symmetric shape, which is of particular advantage with a view to its installation in a suitable headlamp system and for maintenance purposes.

According to an alternative embodiment of the invention, the lens is provided with a mounting rim which permits the lens to be installed in a headlamp in a predefined position, the upper area on the first surface exhibiting an optical scattering effect and/or a surface curvature different from a lower area beneath that upper area.

This permits the imaging and/or scattering behavior of the lens to be adapted very selectively with a view to complying with given specifications.

According to another embodiment of the invention, a diffractive structure is additionally provided on at least one of the two surfaces of the lens.

This likewise permits the optical properties of the lens to be influenced in an advantageous way, for example with a view to producing lenses of highest quality. The diffractive structure may be used in this case, for example, to achieve improved color behavior of the lens due to the resulting light diffraction. There is, for example, also the possibility in this case to provide the diffractive structure only in the upper half of the lens.

According to a preferred further development of that embodiment, the diffractive structure is provided on the second surface of the lens and may be designed, for example, as an element connected with the surface of the lens, which may take the form of a film or the like.

This leads to a simplified manufacturing process as the lens can be produced in this case by hot-pressing and the diffractive structure can be produced by a separate production process and can then be connected with the lens for example by bonding.

With respect to the lighting device, the object of the invention is further achieved by a lighting device, in particular a headlamp for motor vehicle applications, comprising a light source, a reflector and a lens of the kind discussed above, with a mask being additionally positioned between the light source and the reflector.

With respect to the method, the object of the invention is further achieved by a method for manufacturing a lens comprising the following steps:
Melting a glass;
positioning a gob from the melt, adjusting the temperature to a viscosity suited for hot-pressing of the gob;
providing a mold having a first mold surface and at least one second mold surface, wherein areas of different surface roughness are provided at least on the first mold surface;
feeding the gob into the open mold;
hot-pressing the gob for generation of the lens;
cooling the lens down to room temperature.

The manufacturing process according to the invention permits a lens, which complies with given optical specifications for application in a PES headlamp, to be produced solely by hot-pressing, without any finishing treatment of the lens being required, for example by polishing or grinding. The manufacturing method according to the invention therefore guarantees in particular simple, low-cost and reproducible production.

Given the fact that the hot-pressing process starts out from the melt so that due to the increased temperature the viscosity of the glass is comparatively low at the moment the gob portion is fed into the pressing mold, the method permits the surface structure of the mold to be largely transferred to the lens so produced. It is possible with this method to transfer the surface roughness, predetermined by the mold, to the outer surface of the lens with a factor of approximately 1:1.5 or better.

In a lens-manufacturing method according to the prior art, as known for example from DE 100 43 065 A1, where cold gobs are initially heated up to a viscosity suited for the hot-pressing process, the surface structures of the mold can be transferred to the lens only unsatisfactorily, i.e. with a transfer factor of approximately 1:3. This is due to the fact that a considerable temperature difference exists between the core and the surface of heated-up gobs.

An advantageous further development of the method according to the invention uses a mold the first surface of which comprises a marginal area which has a first surface roughness suited for bright-pressing, followed by an area of higher surface roughness toward the middle of the mold.

Further, a mold can be used where the first mold surface has a surface roughness that increases from the edge toward the center, at least over a partial area.

Finally, the mold used may be one where the areas of the first surface, exhibiting different surface roughness values, are configured in such a way that during hot-pressing of the lens areas of higher surface roughness with a mean peak-to-valley height rₘ of maximally 10 micrometers are formed on the first surface of the lens, being molded by the first surface of the mold.

In contrast, according to an advantageous further development of the method of the invention, the areas of lower surface roughness can be configured as bright-pressed areas.

As has been mentioned before, a preferred shape of the lens is plano-convex, which shape is produced by a mold whose first mold surface has a concave shape while its second mold surface has an approximately planar shape.

According to an advantageous further development of the method according to the invention, the lens is cooled down in the mold during the hot-pressing process to a temperature below the glass transformation temperature T_{g}, at least at one of its outer surfaces.

This guarantees safe and durable plastic shaping during the hot-pressing process.

A mold suited for hot-pressing of a lens according to the invention comprises a first mold surface and at least one second mold surface, with areas of different surface roughness values formed at least on the first mold surface.

Such a mold can be produced, for example, by a turning process, combined with a spark-machining or abrasive blasting process for the areas of increased surface roughness.

It is understood that the features of the invention mentioned above and those yet to be explained below can be used not only in the respective combinations indicated, but also in other combinations or in isolation, without leaving the scope of the present invention.

### BRIEF DESCRIPTION OF THE DRAWINGS

Further features and advantages of the invention will be apparent from the following description of certain preferred embodiments with reference to the drawings in which:

FIG. 1 shows an exploded view of a lighting device according to the invention in the form of a PES headlamp;

FIG. 2 shows the optical path of the headlamp according to FIG. 1;

FIG. 3 shows a measuring screen located at a distance in front of the lighting device according to FIG. 1, where the zones prescribed by the respective test specifications can be seen;

FIG. 4 shows a side view of a first embodiment of a lens according to the invention;

FIG. 5 shows a first modification of the lens according to FIG. 4;

FIG. 6 shows a second modification of the lens according to FIG. 4;

FIG. 7 shows a third modification of the lens according to FIG. 4;

FIG. 8 shows a diagrammatic top view of the lens according to FIG. 4, wherein additional annular structures can be seen;

FIG. 9 shows a top view of a levitation mold in the process of producing a lens, for supporting a gob on a gas veil;

FIG. 10 shows a side view of the levitation mold according to FIG. 9, together with a gob floating above the mold on a gas flow; and

FIG. 11 shows a diagrammatic section through a mold for the production of a lens according to the invention by hot-pressing.

### DETAILED DESCRIPTION OF THE PREFERRED EMBODIMENTS

A PES headlamp according to the invention is shown in FIG. 4 and is indicated generally by reference numeral 20. The PES headlamp 20 consists of a poly-ellipsoid reflector 24, a light source 22, for example in the form of a halogen lamp, a mask 26 and a lens 28. The masks 26 usually used shade off the lower half of the light beam so that the light of the headlamp, once it has issued behind the lens 28, proceeds substantially in downward direction. By stepping the upper edge of the mask 26 it is ensured that the light beam will be directed especially to the right and to the bottom so as to ensure that the oncoming traffic will be dazzled as little as possible.

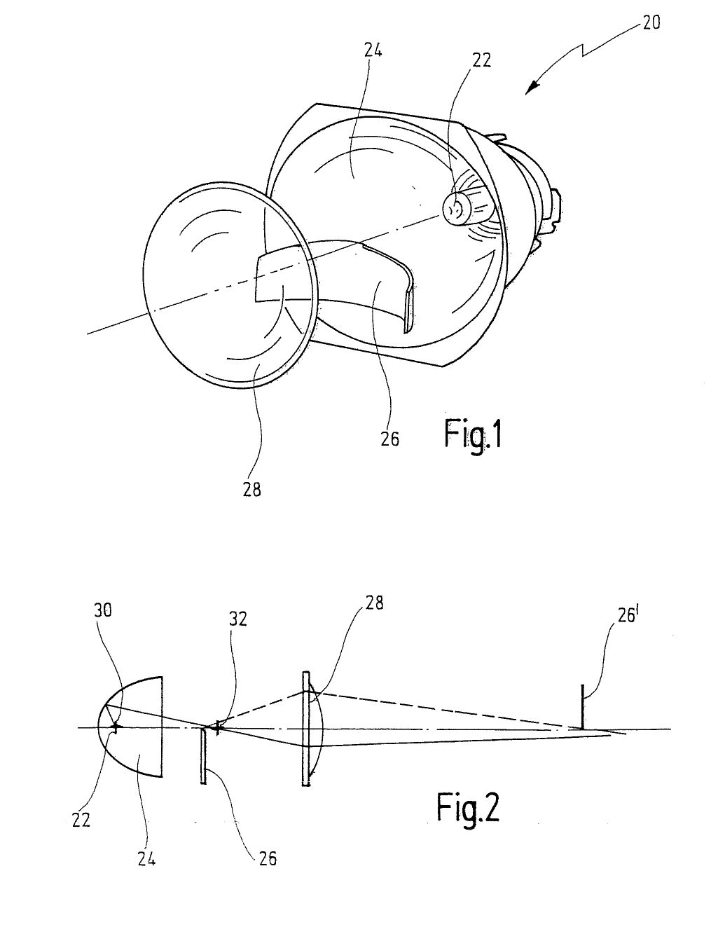

The optical path of a PES headlamp is illustrated in FIG. 2. A lamp 22 is arranged in a first focal point 30 of the reflector 24. Due to the ellipsoid shape of the reflector 24, the light is focused in a second focal point 32 located a short way behind the mask 26. Thereafter, the individual light rays pass the lens 28, creating an image 26′ of the mask 26 at a distance of approximately 10 m, for example.

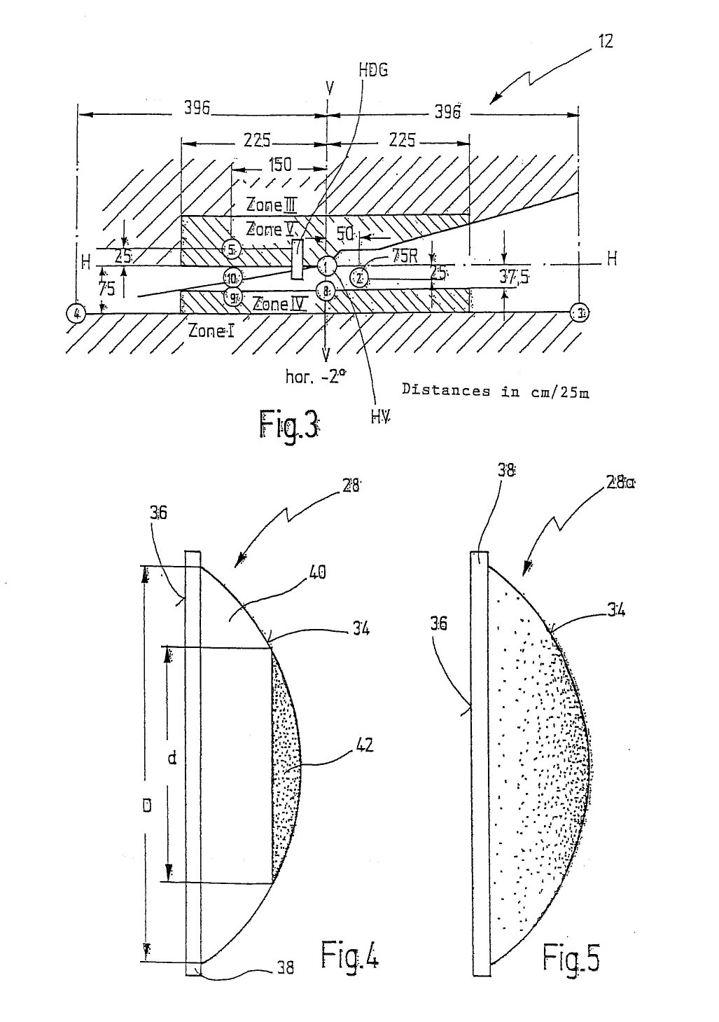

The light distribution of such a PES headlamp must comply with a number of legal requirements. Further, the manufacturers of headlamps have their own specifications aimed at complying with the legal requirements or the requirements formulated by the vehicle manufacturers. The different zones and reference lighting points obtained when a vertical screen is illuminated by such a headlamp are represented in FIG. 3. In FIG. 3, the line V-V designates the vertical center line, the line H-H the horizontal center line. The different reference points are encircled in the drawing.

In particular the HV value is an important value for the purpose of assessing the PES headlamp. As can be seen in FIG. 3, the HV point \textcircled{1} is located 25 cm above the illuminated area at a distance of 25 m behind the lens. In the horizontal direction, the HV point is located exactly above the step of the low-beam cut-off produced by the step in the edge of the mask 26. The illuminance at the HV point must be ≦1 lux, preferably even less.

Another important criterion is a soft transition at the low-beam cut-off. At the left side in FIG. 3, beside the HV point, a measuring range is shown as a rectangle indicated “HDG”, which marks the measuring path for determination of the so-called HDG value at the transition from the bright to the bark area.

A lens according to the invention, suited for complying with all prescribed specifications, is shown in FIG. 4 and is indicated generally by reference numeral 28.

The lens 28 is a plano-convex lens whose first surface 34 has a convex shape and whose second, opposite surface 36 has an approximately planar shape. The lens 28 comprises a peripheral mounting rim 38, not part of the optically effective surface. Preferably, the lens 28 is made from glass, produced by hot-pressing, preferably from a glass type B270 (as per Schott specifications).

According to the invention, the lens 28 now comprises on its convex side, i.e. on its first surface 34, a marginal area 40 which extends in annular form from the outer circumference D toward the inside, and which is followed by a second area 42 having an increased optical scattering effect and/or increased surface roughness. While the marginal area 40 is plain, i.e. optically bright, the area 42 exhibits increased surface roughness with a mean peak-to-valley height rₘ of maximally 10 micrometers, preferably in the range of between approximately 3 and 5 micrometers. Compared with that, the plain marginal area 40 has a peak-to-valley height lower by more than one order of magnitude, for example in the order of approximately 400 nm.

The marginal area 40 has a diameter d which extends over an area equal to D≦d≦0.65, preferably over an area equal to D≦d≦0.75 D, most preferably over an area equal to approximately D≦d≦0.8 D, where D is the diameter of the optically effective area. Lenses of that kind are produced for usual PES headlamps in diameters of approximately 30 to 70 mm. For a lens diameter D of 70 mm, the marginal area 40 could therefore extend from 70 mm to 56 mm in diameter. By making the lens 28 plain, i.e. optically bright, in its marginal area 40 and giving it an increased surface roughness in its central area 42, it is possible to guarantee compliance with both the HV value and the HDG value without any need for further measures. The invention now permits to produce such a lens 28 by a single hot-pressing process, without any need for after-treating operations, such as grinding, polishing, sand-blasting, or the like.

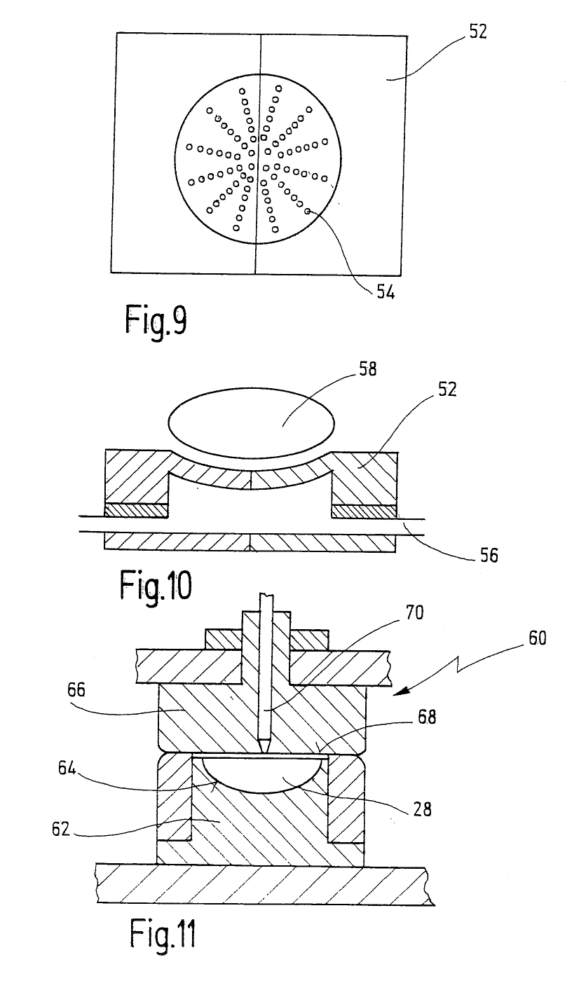

A manufacturing method of that kind will be shortly described hereinafter with reference to FIGS. 9 to 11.

To begin with, a suitable glass, for example a glass type B270, is molten in a melting oven, which process takes place at a viscosity in the range of approximately 10³ to approximately 10⁴ poise. In the case of the glass type mentioned above, the process can be conducted, for example, at a temperature of 1110° Celsius. Once the glass is molten, it is divided into separate portions suited for a subsequent hot-pressing process by which the lenses are produced. Such portions of the glass mass are also known as “gobs”. Dividing the glass into gobs is preferably effected at the outlet of the melting pan using glass-cutting shears. The gob is then transferred onto a gas bed or a levitation mold 25, as shown in FIGS. 9 and 10, where the gob 58 is kept in floating condition on gas emitted by gas nozzles 54. Due to the active gravitational forces and its relatively low viscosity, the gob assumes the approximate shape of a lens, as indicated in FIG. 10. The gas flowing from the gas nozzles 54 passes a supply channel 56 by which it is supplied into the levitation mold 52 from below. Depending on the particular glass type, the gas so supplied may be air or a protective gas, for example nitrogen.

Thereafter, the gob 58 is transferred from the levitation mold 52 into a pressing mold indicated generally by reference numeral 60 in FIG. 11.

It is understood that the pressing mold shown in FIG. 11 is intended as an example only and that certain details, such as the ejector, the venting channels, and the like, are not shown, being not relevant in the present case. The pressing mold 60 comprises a first mold half 62 in which the convex portion of the lens 28 to be pressed is formed by a first molding surface 64. A second mold half 66 comprises a second molding surface 68 intended to produce the planar side of the lens 28. The second mold half 66 is further provided with a central channel 70 for venting purposes.

The first molding surface 64 exhibits a suitable design to ensure that the lens 28 produced by the hot-pressing process will comprise the plain marginal area 40 and the central area 42 with increased optical scattering effect on its convex side. The molding surface 64 may be surface-treated in a suitable way and may be roughened in a predetermined area so as to produce the desired surface roughness and/or optical scattering effect at the desired geometric position of the finished lens, without any subsequent after-treatment being required. The two mold halves 62, 66 are worked by suitable processes, such as turning, milling, spark erosion, laser processing, etc. The areas where the surface of the lens is to be plain are polished or ground, if necessary, to obtain the desired surface roughness. An excessively rough surface must also be prevented because otherwise the surface may stick to the mold during the hot-pressing process. The areas, which exhibit the increased surface roughness, may be produced for example by a blasting process (for example glass bead blasting), by spark erosion, laser processing or in some other way.

The manufacturing method now operates as follows: Once a gob 58 has been separated from the material in the melting pan, the mass is initially adjusted, on the levitation mold 52, to a viscosity suitable for the subsequent hot-pressing process, i.e. a viscosity in the range of approximately 10^{3.3} poise, which corresponds to a temperature of approximately 950 to 1000° Celsius if glass type B270 is used. The hot-pressing process is then carried out within a viscosity range of approximately 10⁸ to 10¹² poise, preferably approximately 10^{9.6} poise in the case of B270 glass.

A modification of the lens according to the invention is illustrated in FIG. 5 and is indicated generally by reference numeral 28a.

While in the case of the embodiment according to FIG. 4 the marginal area 40 is clearly defined against the central area 42 with increased optical scattering effect and/or surface roughness (although the transition is as smooth as possible in order to avoid the occurrence of diffraction phenomena) the lens 28a illustrated in FIG. 5 exhibits a smoothly graded surface 34. The optical scattering effect increases in this case continuously from the outer edge to the center of the lens 28a.

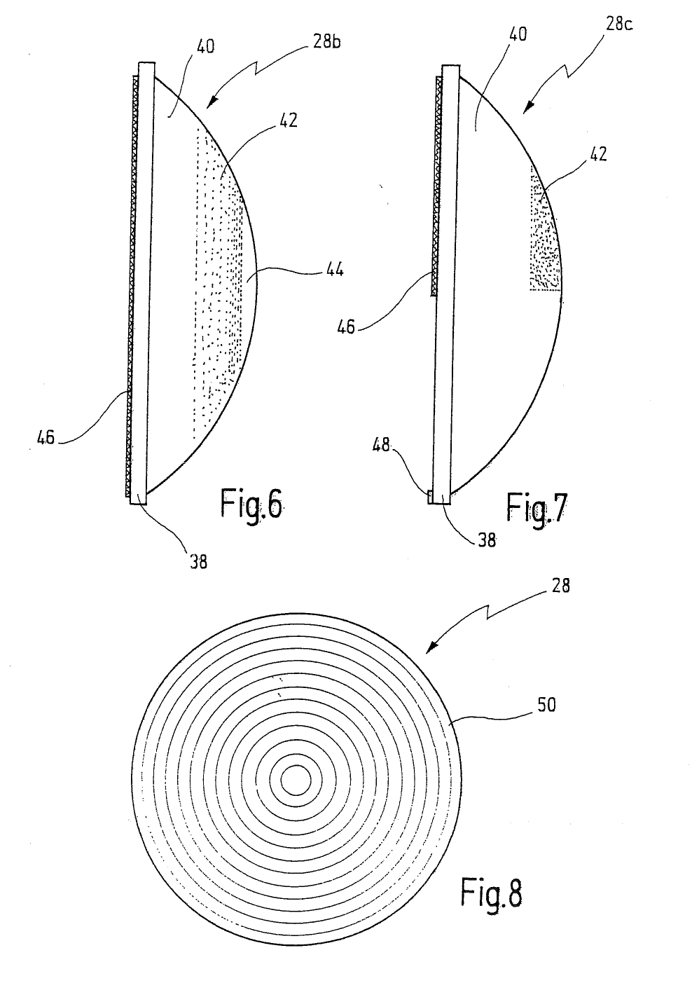

Another modification of a lens according to the invention is illustrated in FIG. 6 and is indicated generally by reference numeral 28b. Here again, a bright marginal area 40 is provided on the convex side, followed by an area 42 with increased optical scattering effect and/or surface roughness. In the area 42, the surface roughness again increases from the greater diameter toward the center. But contrary to the lens 28 according to FIG. 5, a small central area 44 on the convex side of the lens 28b is made bright in this case.

One makes use in this case of the fact that the central area of a lens of a PES headlamp has practically no effect whatsoever on the HV value and on the HDG value.

The lens 28b according to FIG. 6 may now be additionally provided with a diffractive element 46, for example on its planar side. That element may consist, for example, of a film bonded onto the planar side. As is generally known, it is possible with the aid of a diffractive element to favorably influence certain properties of the lens 28b by diffractive effects. With the aid of a diffractive element it is possible, for example, to reduce a color fringe caused by the color dispersion of the lens.

FIG. 7 shows another variant of a lens according to the invention, indicated generally by reference numeral 28c. In this case, the convex side of the lens 28c is again provided with a plain marginal area. A central area 42 of increased optical scattering effect and/or surface roughness is, however, provided only in the upper half of the lens. Correspondingly, a diffractive element 46, applied on the planar side of the lens 28c, is likewise provided only in the upper half of the lens 28c. This may consist, for example, of concentrically arranged diffraction structures. In order to permit such a lens 28c to be installed in the correct position in a headlamp mount, a positioning nose 48 is formed on the lower end of the mounting rim 38.

The front view of FIG. 8 further shows that the lens according to the invention may be additionally provided with a ring structure 50, for example on its convex side. This may consist, for example, of concentric rings provided at a spacing of 1 mm, with a depth in the order of approximately 1 to 10 micrometers. Smooth transitions are guaranteed in this case, for example, if the arrangement is configured as a sinusoidal oscillation. A ring structure 50 of that kind has practically no optical effects and is requested by part of the automobile industry merely under design aspects.

It is understood that, generally, the lens according to the invention might by produced also from a suitable plastic material by a pressing or stamping method (preferably a UV and hot-stamping method). With respect to the plastic materials, transparent plastic materials and such with long-time stability are preferred for this purpose. Suited plastic materials are, for example, polymethyl methacrylimide (PMMI), which is highly stable under heat, or else cycloolefin copolymers (COC) or cycloolefin polymers (COP), which practically do not absorb any water.

What is claimed is:

1. A method of manufacturing a lens having first and second opposite optical surfaces with the first optical surface having a convex shape, comprising the steps of:
melting a glass;
portioning a gob from the melt;
adjusting the temperature of the gob to a viscosity suited for hot-pressing of the gob;
providing a hold having a first generally concave mold surface and a second mold surface for forming said first and second optical surfaces, respectively, of the lens;
feeding the gob into the open mold;
hot-pressing the gob in said mold for generating said lens; and
cooling the lens down to room temperature;
wherein said first mold surface includes areas exhibiting different surface roughness values comprising a central region having a higher mean surface roughness of maximally 10 micrometers and a marginal region having a lower mean surface roughness of maximally 1 micrometer, such that the lens produced by said hot-pressing mold step results in a refractive lens having a corresponding central region on said first optical surface that is configured to provide broader scattering of light emerging therefrom than light emerging from a corresponding marginal region of said first optical surface.

2. The method of claim 1, wherein said first optical surface of said lens comprises surface roughness characteristics in said central and marginal regions thereof that are transferred directly from the corresponding regions of said first mold surface during said hot-press molding step without further processing of the lens.

3. The method of claim 2, wherein the lens is cooled down in the mold to a temperature below the glass transformation temperature at least at one of its surfaces.

4. The method of claim 3, wherein the second optical surface of the lens has a generally planar shape.

5. The method of claim 1, wherein the surface roughness of at least the central region of said first mold surface is obtained by sand blasting.
